(19) United States
(12) Patent Application Publication
(10) Pub. No.: US 2026/0251001 A1
(43) Pub. Date: Aug. 27, 2026

(54) OPENING/CLOSING BODY CONTROL APPARATUS AND ENTRAPMENT DETECTION METHOD

(71) Applicants: DENSO CORPORATION, Kariya-city (JP); OSAKA SANGYO UNIVERSITY, Osaka (JP)

(72) Inventors: Yuki DATE, Kariya-city (JP); Tsutomu TASHIRO, Daito-shi (JP)

(73) Assignees: DENSO CORPORATION, Kariya-city (JP); OSAKA SANGYO UNIVERSITY, Osaka (JP)

(21) Appl. No.: 19/652,628

(22) Filed: Apr. 20, 2026

Related U.S. Application Data
(63) Continuation of application No. PCT/JP2024/036905, filed on Oct. 16, 2024.

(30) Foreign Application Priority Data
Oct. 20, 2023 (JP) 2023-181237

(51) Int. Cl. E05F 15/40

(52) U.S. Cl. CPC E05F 15/40; E05Y 2400/36; E05Y 2400/44; E05Y 2400/554; E05Y 2900/531; E05Y 2900/542; E05Y 2900/55

(57) ABSTRACT

An opening/closing body control apparatus includes: a load estimation unit that estimates a load caused to an opening/closing body during an opening operation or a closing operation; a first filter that removes at least noise from a waveform of the estimated load obtained by the load estimation unit; a second filter that removes, from the waveform of the estimated load, frequencies lower than those removed by the first filter; an offset calculation unit that calculates an offset value of the estimated load based on an output of the first filter; and an entrapment determination unit that performs an entrapment determination for the opening/closing body. Moreover, the entrapment determination unit is configured to: monitor whether entrapment has started based on an output of the second filter; and perform the entrapment determination based on the offset value fixed when the start of entrapment is detected and the output of the first filter.

### CROSS-REFERENCE TO RELATED APPLICATIONS

The present application is a continuation application of International Application No. PCT/JP2024/036905 filed on Oct. 16, 2024, which is based on and claims priority from Japanese Patent Application No. 2023-181237 filed on Oct. 20, 2023. The entire contents of these applications are incorporated by reference into the present application.

### BACKGROUND

### 1 Technical Field

The present disclosure relates to opening/closing body control apparatuses and entrapment detection methods.

### 2 Description of Related Art

Conventionally, as disclosed in Japanese Unexamined Patent Application Publication No. JP 2019-206329 A, door control apparatuses have been well known which can detect entrapment of an object between a door and a door pocket during a door opening operation. The aforementioned patent document describes: providing a resistance force estimation unit configured to estimate a resistance force that causes variation in the speed of the door; and detecting entrapment of an object between the door and the door pocket when the resistance force estimated by the resistance force estimation unit exceeds a predetermined value. Moreover, the aforementioned patent document also describes estimating the resistance force by using a dynamic model such as an equation of motion.

### SUMMARY

For example, as an entrapment determination using a dynamic model, a method may be considered in which: a threshold value is set with respect to the resistance force estimated by the dynamic model; and when the estimated resistance force exceeds the threshold value, it is determined that entrapment has occurred. However, when a sliding load fluctuation occurs during the operation of the door and/or the device has deteriorated, the speed of the door varies due to these factors. As a result of detailed studies conducted by the inventors of the present application, it has been recognized that: when variation in the speed of the door occurs, the estimated resistance force includes values resulting from the above-described factors; therefore, an error occurs between the estimated resistance force and the actual resistance force caused by entrapment. Consequently, a problem has been found that entrapment may be erroneously detected.

In order to reduce the aforementioned error, for example, a method of applying a filter to the calculated resistance force may be considered. However, the inventors have found that: with this method, a delay occurs due to the filtering; consequently, the detection of entrapment may be delayed. That is, the inventors have also found that the above-described problem cannot be solved by a simple method of merely filtering the calculated resistance force.

The present disclosure has been accomplished in view of the above circumstances.

An opening/closing body control apparatus according to the present disclosure includes: a load estimation unit configured to estimate a load caused to an opening/closing body during an opening operation or a closing operation; a first filter configured to remove at least noise from a waveform of the estimated load obtained by the load estimation unit; a second filter configured to remove, from the waveform of the estimated load, frequencies lower than those removed by the first filter; an offset calculation unit configured to calculate an offset value of the estimated load based on an output of the first filter; and an entrapment determination unit configured to perform an entrapment determination for the opening/closing body based on the output of the first filter and an output of the second filter. Moreover, the entrapment determination unit is further configured to: monitor whether entrapment has started based on the output of the second filter; and perform the entrapment determination based on the offset value fixed when the start of entrapment is detected and the output of the first filter.

An entrapment detection method according to the present disclosure is a method of detecting, by a computer, entrapment of an object due to an opening/closing body during an opening operation or a closing operation. The entrapment detection method includes: a step of estimating a load caused to the opening/closing body during the opening operation or the closing operation; a step of removing, by a first filter, at least noise from a waveform of the estimated load obtained in the estimating step; a step of removing, by a second filter, frequencies from the waveform of the estimated load, the frequencies being lower than those removed by the first filter; a step of calculating an offset value of the estimated load based on an output of the first filter; a step of monitoring whether entrapment has started based on an output of the second filter; a step of fixing the offset value when the start of entrapment is detected based on the output of the second filter; and a step of performing an entrapment determination based on the fixed offset value and the output of the first filter.

According to the present disclosure, the estimated load obtained by the load estimation unit is filtered by the first filter, thereby being converted into a waveform that prioritizes the securing of gain. Moreover, the estimated load obtained by the load estimation unit is also filtered by the second filter, thereby being converted into a waveform that prioritizes reduction in the error of the estimated load. Then, both the output of the first filter and the output of the second filter are used to determine whether entrapment has occurred. Performing the entrapment determination by using the waveform that prioritizes the securing of gain, the responsiveness of the entrapment determination can be improved. Performing the entrapment determination by using the waveform that prioritizes the securing of gain, the responsiveness of the entrapment determination can be improved. Moreover, performing the entrapment determination by using the waveform that prioritizes reduction in the error of the estimated load, a determination result having low probability of erroneous detection can be obtained. Consequently, it becomes possible to achieve both high responsiveness and suppression of erroneous detection of entrapment.

### BRIEF DESCRIPTION OF THE DRAWINGS

FIG. 1 is a block diagram illustrating the configuration of an opening/closing body control apparatus according to an embodiment.

FIG. 2 is an explanatory diagram illustrating the outline of a model.

FIG. 3A is a waveform chart illustrating the output of a first filter.

FIG. 3B is a waveform chart illustrating the output of the first filter after offset removal.

FIG. 4A is a waveform chart illustrating the output of a second filter.

FIG. 4B is a waveform chart illustrating an example of detecting the start of entrapment.

### DESCRIPTION OF EMBODIMENTS

Hereinafter, an embodiment of the present disclosure will be described.

### (Opening/Closing Body Control Apparatus 1)

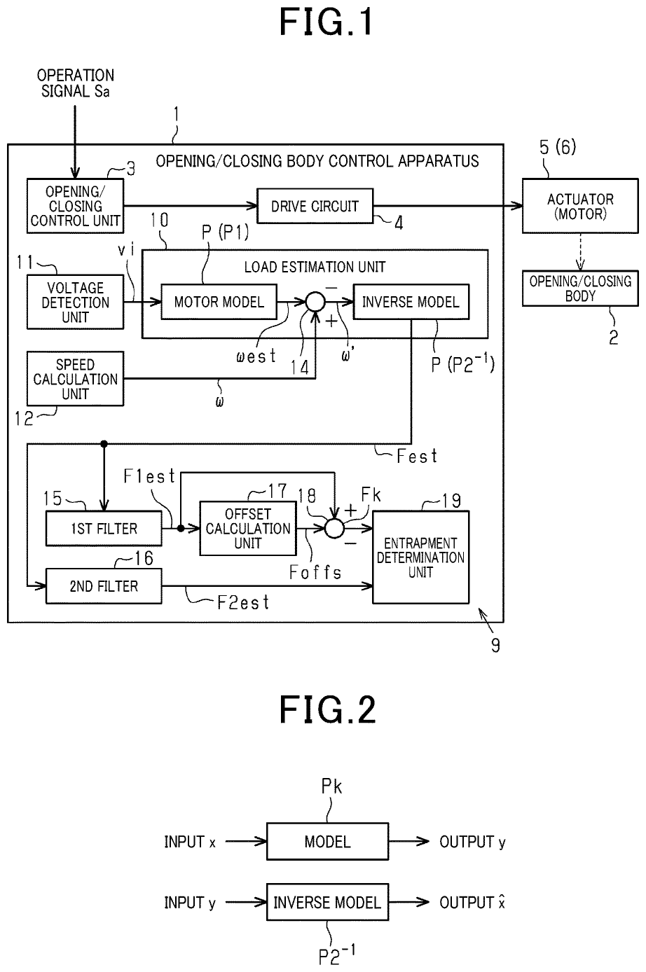

As shown in FIG. 1, in a vehicle that has an opening/closing body 2, there is installed an opening/closing body control apparatus 1 that controls operation of the opening/closing body 2. The opening/closing body control apparatus 1 includes an opening/closing control unit 3 that manages operation of the opening/closing body control apparatus 1. The opening/closing control unit 3 controls an actuator 5 through a drive circuit 4 based on an externally-inputted operation signal Sa, thereby causing the opening/closing body 2 to perform an opening operation or a closing operation. Examples of the opening/closing body 2 include a window provided in a door, a sunroof provided in a roof of a vehicle body, and a sliding door that opens and closes a passenger entrance of a vehicle by being moved parallel to the vehicle body. The actuator 5 may be implemented by, for example, a motor 6.

### (Entrapment Detection Function)

As shown in FIG. 1, the opening/closing body control apparatus 1 includes an entrapment detection device 9 that detects whether entrapment has occurred at the opening/closing body 2 during operation of the opening/closing body 2. In the present embodiment, the entrapment detection device 9 detects whether an object has been entrapped by the opening/closing body 2 in operation. In addition, examples of entrapment to be detected by the entrapment detection device 9 may include entrapment that occurs when an object is entrapped between the opening/closing body 2 and a frame (not shown) during the closing operation of the opening/closing body 2, or entrapment that occurs when an object is entangled by the opening/closing body 2 during the opening operation of the opening/closing body 2.

The entrapment detection device 9 includes a load estimation unit 10 that estimates a load caused to the opening/closing body 2 during the opening operation or the closing operation. Specifically, the load estimation unit 10 receives a motor voltage value vᵢ from a voltage detection unit 11 that detects a voltage applied to the motor 6, and receives a motor angular speed ω from a speed calculation unit 12 that detects a rotational speed of the motor 6. Then, the load estimation unit 10 estimates the load based on the motor voltage value vᵢ and the motor angular speed ω.

The load estimation unit 10 has a model P for estimating an entrapment load caused to the opening/closing body 2. In the present embodiment, the model P includes a motor model P1 and an inverse model P2⁻¹. The motor model P1 is a model which estimates the angular speed of the motor 6 (to be referred to as the estimated angular speed ωest hereinafter) based on an input that is the motor voltage value vᵢ outputted from the voltage detection unit 11. On the other hand, the inverse model P2⁻¹ is a model which estimates the load caused to the opening/closing body 2 based on an input that is the difference between the estimated angular speed ωest outputted from the motor model P1 and the motor angular speed ω outputted from the speed calculation unit 12, i.e., is the angular speed caused by an external force (to be referred to as the external-force angular speed ω′ hereinafter).

As shown in FIG. 2, the model P represents the relationship between an input and an output of the opening/closing body 2, which is a controlled object, by using predetermined physical formulars. For example, when an output y can be obtained by inputting an input x to a model Pk (i.e., a forward model), the input x to the model Pk can be estimated by inputting the output y of the model Pk as an input to the inverse model P2⁻¹. Based on this principle, in the present embodiment, the entrapment load, which corresponds to the input to the model Pk, is estimated by inputting the angular speed caused by an external force (i.e., the external-force angular speed ω′) to the inverse model P2⁻¹.

As shown in FIG. 1, the load estimation unit 10 includes a difference calculation unit 14 that calculates the difference between the estimated angular speed ωest outputted from the motor model P1 and the motor angular speed ω that is an actual value outputted from the speed calculation unit 12. The difference calculation unit 14 outputs the obtained difference, i.e., the external-force angular speed ω′ which is an angular speed caused by an external force, to the inverse model P2⁻¹. The inverse model P2⁻¹ receives the external-force angular speed ω′ as an input, and calculates an estimated load Fest as an output thereof.

The entrapment detection device 9 includes a first filter 15 and a second filter 16 that have different frequency characteristics from each other. The first filter 15 and the second filter 16 may be, for example, digital filters. The first filter 15 removes at least noise from a waveform of the estimated load Fest obtained by the load estimation unit 10. That is, the first filter 15 performs the minimum necessary noise removal for preventing decrease in the gain. The second filter 16 removes, from the waveform of the estimated load Fest obtained by the load estimation unit 10, frequencies lower than those removed by the first filter 15. That is, the second filter 16 has a higher degree of removable of low frequencies than the first filter 15 in order to suppress errors.

The entrapment detection device 9 also includes an offset calculation unit 17 that calculates an offset value Foffs of the estimated load Fest based on the output of the first filter 15. The offset value Foffs includes an error caused by change in the speed of the opening/closing body 2 due to, for example, a sliding load fluctuation during operation of the opening/closing body 2 and/or deterioration of the device. Therefore, even when entrapment has not actually occurred, entrapment may be detected by detection of a load caused by a sliding load fluctuation and/or deterioration of the device.

The entrapment detection device 9 also includes a difference calculation unit 18 that calculates the difference between a first estimated load F1est outputted from the first filter 15 and the offset value Foffs outputted from the offset calculation unit 17. That is, the difference calculation unit 18 calculates an offset-removed estimated load Fk by subtracting the offset value Foffs from the first estimated load F1est.

The entrapment detection device 9 also includes an entrapment determination unit 19 that performs an entrapment determination for the opening/closing body 2 based on the outputs of the first and second filters 15 and 16. In the present embodiment, the entrapment determination unit 19 receives a second estimated load F2est from the second filter 16, and receives the offset-removed estimated load Fk from the difference calculation unit 18. Then, based on the second estimated load F2est and the offset-removed estimated load Fk, the entrapment determination unit 19 determines whether entrapment has occurred due to the opening/closing body 2.

In the present embodiment, the entrapment determination unit 19 monitors whether entrapment has started based on the output of the second filter 16 (i.e., the second estimated load F2est). When it is determined that entrapment has started, the entrapment determination unit 19 causes the offset calculation unit 17 to fix the offset value Foffs. The entrapment determination unit 19 performs the entrapment determination based on the offset value Foffs fixed when the start of entrapment is detected and the output of the first filter 15 (i.e., the first estimated load F1est). In other words, the entrapment determination unit 19 performs, after the offset value Foffs is fixed, the entrapment determination based on the offset-removed estimated load Fk inputted from the difference calculation unit 18.

Next, operation of the opening/closing body control apparatus 1 (or entrapment detection method) according to the present embodiment will be described.

### (Details of Model P)

The motor model P1 and the inverse model P2⁻¹ shown in FIG. 1 are expressed by converting a voltage equation and an equation of motion into a state-space representation and then converting the state-space representation into a transfer function. The motor model P1 and the inverse model P2⁻¹ can be expressed by, for example, the following Equations (1) to (3). It should be noted that: the symbols in the equations represent parameters relating to the entire motor; and (′) in the equations represents differentiation.

$$Li ’ + Ri = {v}_{i} - {K}_{b} ω \qquad ( 1 )$$

$${K}_{t} i = J ω ’ + C ω + {GF}_{w} \qquad ( 2 )$$

$${w}_{m} ’ = - ( 1 / τ ) {ω}_{m} + ( 1 / τ ) ω \qquad ( 3 )$$

The meanings of the symbols in Equations (1) to (3) are as follows. R: internal resistance; L: inductance; K_{b}: back electromotive force coefficient; Kₜ: torque constant; J: moment of inertia; C: damping coefficient; i: current; vᵢ: motor voltage value; ω: motor angular speed; F_{w}: external force acting on the window; G: conversion coefficient; τ: time constant; ωₘ: angular speed used for the model calculation.

As above, the load estimation unit 10 estimates the load caused to the opening/closing body 2 by using the model P (i.e., the motor model P1 and the inverse model P2⁻¹) obtained by converting the state-space representation relating to operation of the motor 6, which is the power source of the opening/closing body 2, into the transfer function representation.

### (Operation of Entrapment Detection)

As shown in FIG. 1, the entrapment detection device 9 estimates the load acting on the opening/closing body 2 based on the motor voltage value vᵢ inputted from the voltage detection unit 11 and the motor angular speed ω inputted from the speed calculation unit 12. In the present embodiment, the entrapment detection device 9 performs the operation sequentially while the vehicle is powered on.

In the present embodiment, the load estimation unit 10 calculates the estimated angular speed ωest by substituting the motor voltage value vᵢ inputted from the voltage detection unit 11 into the motor model P1 that is built based on the above-described Equations (1) to (3). Specifically, the load estimation unit 10 calculates the estimated angular speed ωest by using the following Equation (4).

$$ω est = P 1 \times {v}_{i} \qquad ( 4 )$$

The load estimation unit 10 outputs the calculated estimated angular speed ωest to the difference calculation unit 14. The difference calculation unit 14 calculates the external-force angular speed ω′ by calculating the difference between the estimated angular speed ωest inputted from the motor model P1 and the motor angular speed ω inputted from the speed calculation unit 12. The external-force angular speed ω′ corresponds to the angular speed caused to the opening/closing body 2 by an external force applied to the opening/closing body 2. The difference calculation unit 14 outputs the calculated external-force angular speed ω′ to the inverse model P2⁻¹.

The load estimation unit 10 calculates the estimated load Fest by substituting the external-force angular speed ω′ calculated by the difference calculation unit 14 into the inverse model P2⁻¹ that is also built based on the above-described Equations (1) to (3). The estimated load Fest may include, for example, a load that is generated, when an external force is applied to the opening/closing body 2, due to the external force. The load estimation unit 10 calculates the estimated load Fest by using the following Equation (5).

$$Fest = P {2}^{- 1} \times ( ω - ω est ) \qquad ( 5 )$$

Then, the load estimation unit 10 outputs the calculated estimated load Fest to each of the first and second filters 15 and 16. As above, in the present embodiment, the load estimation unit 10 outputs the output of the inverse model P2⁻¹ as the estimated load Fest to the first and second filters 15 and 16.

The first filter 15 calculates the first estimated load F1est by filtering the estimated load Fest inputted from the load estimation unit 10. In the present embodiment, the first filter 15 is represented by the following Equation (6). It should be noted that Tis in Equation (6) is the time constant set for the first filter 15.

$${Q}_{1} ( s ) = 1 / \{ ( {τ}_{1} s + 1 ) ( {τ}_{1} s + 1 ) \} \qquad ( 6 )$$

The first estimated load F1est is calculated by the following Equation (7).

$$F 1 est = Fest \times {Q}_{1} ( s ) \qquad ( 7 )$$

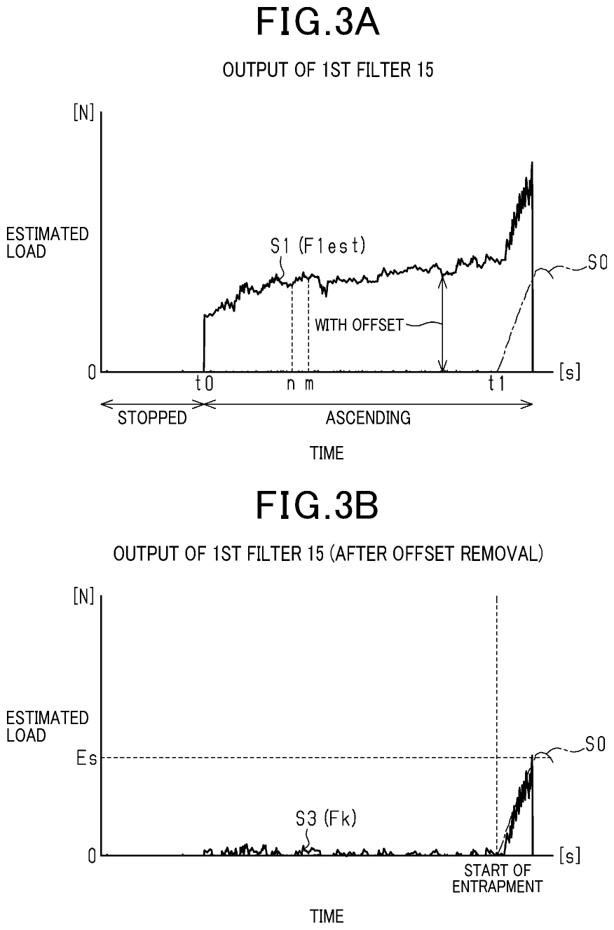

FIG. 3A shows the load waveform S1 of the first estimated load F1est outputted from the first filter 15. In the figure, there is shown the load waveform S1 when the opening/closing body 2 ascends in the closing operation. Moreover, in the figure, an ideal waveform S0, which is a waveform when the opening/closing body 2 ascends without occurrence of any sliding load fluctuations or deterioration in the opening/closing body 2, is shown by a one-dot chain line.

When a sliding load fluctuation occurs during the operation of the opening/closing body 2 and/or the device has deteriorated, a large load value will be detected (at a time instant t0), upon the opening/closing body 2 being switched from a stopped state to an ascending state, due to factors such as the sliding load fluctuation and/or the deterioration of the device, even though no entrapment has actually occurred. Further, with increase in the load, the ascending speed of the opening/closing body 2 decreases while the load gradually increases. Furthermore, during the ascending of the opening/closing body 2, the load changes suddenly and significantly (at a time instant t1) at the timing when entrapment actually occurs.

As can be seen from the figure, an advantage of the first filter 15 is, for example, that there is less gain decrease due to the filtering. However, the load waveform S1 includes a load caused by the sliding load fluctuation and/or the deterioration of the device; therefore, the load waveform S1 is offset from the actual load by the offset value Foffs. Thus, it can be seen that a disadvantage of the first filter 15 is that the offset (or error) of the estimated load Fest is large. In addition, the equation representing the first filter 15 is not limited to Equation (6), but may alternatively be any equation that satisfies the aforementioned advantage.

As shown in FIG. 1, the second filter 16 calculates the second estimated load F2est by filtering the estimated load Fest inputted from the load estimation unit 10. In the present embodiment, the second filter 16 is represented by the following Equation (8). It should be noted that T2s in Equation (8) is the time constant set for the second filter 16.

$${Q}_{2} ( s ) = 1 / \{ ( {τ}_{2} s + 1 ) ( {τ}_{2} s + 1 ) \} \qquad ( 8 )$$

The second estimated load F2est is calculated by the following Equation (9).

$$F 2 est = Fest \times {Q}_{2} ( s ) \qquad ( 9 )$$

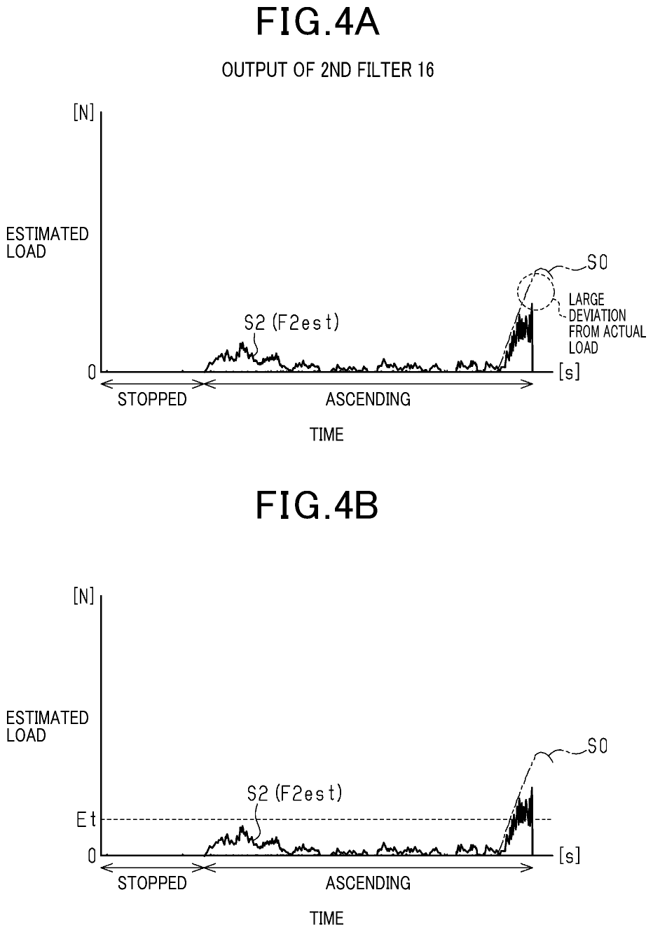

FIG. 4A shows the load waveform S2 of the second estimated load F2est outputted from the second filter 16. In the figure, there is shown the load waveform S2 when the opening/closing body 2 ascends; and there is also shown the ideal waveform S0 by a one-dot chain line. As can be seen from the figure, an advantage of the second filter 16 is, for example, that the error in the estimated load is small. On the other hand, a disadvantage of the second filter 16 is that after entrapment actually occurs, a large deviation of the second estimated load F2est from the actual load occurs due to decrease in the gain. In addition, the equation representing the second filter 16 is not limited to Equation (8), but may alternatively be any equation that satisfies the aforementioned advantage.

As shown in FIG. 1, the first filter 15 outputs the calculated first estimated load F1est to both the offset calculation unit 17 and the difference calculation unit 18. On the other hand, the second filter 16 outputs the calculated second estimated load F2est to the entrapment determination unit 19.

The offset calculation unit 17 calculates the offset value Foffs included in the first estimated load F1est inputted from the first filter 15. In the present embodiment, the offset calculation unit 17 repeatedly performs, for each computer control cycle, the process of determining, as the offset value Foffs, the average value of a plurality of load values (i.e., values of the first estimated load F1est) traced back from a current time to past times. Specifically, the offset calculation unit 17 calculates the offset value Foffs by using the following Equation (10). It should be noted that: in Equation (10), m and n indicate the measurement order of the offset value Foffs; and the relationship between them is m<n.

$${F}_{offs} = \frac{1}{n - m + 1} {\sum }_{k = m}^{n} F 1 est ( k ) \qquad ( 10 )$$

The offset calculation unit 17 outputs the calculated offset value Foffs to the difference calculation unit 18. The difference calculation unit 18 calculates the offset-removed estimated load Fk based on the first estimated load F1est inputted from the first filter 15 and the offset value Foffs inputted from the offset calculation unit 17. Specifically, the difference calculation unit 18 calculates the offset-removed estimated load Fk as the result of by subtracting the offset value Foffs from the first estimated load F1est.

FIG. 3B shows the load waveform S3 of the offset-removed estimated load Fk. As can be seen from the figure, the offset-removed estimated load Fk has a waveform that is lowered by the offset value Foffs from the load waveform S1 of the first estimated load F1est. Moreover, before the offset value Foffs is fixed, the offset-removed estimated load Fk takes values close to 0. The difference calculation unit 18 outputs the calculated offset-removed estimated load Fk to the entrapment determination unit 19.

The entrapment determination unit 19 performs the entrapment determination based on both the second estimated load F2est inputted from the second filter 16 and the offset-removed estimated load Fk inputted from the difference calculation unit 18. Specifically, the entrapment determination unit 19 first performs an entrapment start determination based on the second estimated load F2est, and then performs the entrapment determination based on the offset-removed estimated load Fk.

As shown in FIG. 4B, in the present embodiment, the entrapment determination unit 19 monitors the start of entrapment by comparing the second estimated load F2est inputted from the second filter 16 with an entrapment start determination threshold Et. When no entrapment has occurred, the load is low and thus the second estimated load F2est does not exceed the entrapment start determination threshold Et. In contrast, upon occurrence of entrapment, the load becomes high and thus the second estimated load F2est also becomes high. Therefore, the entrapment determination unit 19 determines, when the second estimated load F2est exceeds the entrapment start determination threshold Et, that entrapment has started.

Upon detection of the start of entrapment, the entrapment determination unit 19 fixes the offset value Foffs calculated by the offset calculation unit 17. Specifically, upon detection of the start of entrapment, the entrapment determination unit 19 outputs an offset-value fixing command to the offset calculation unit 17, thereby causing the offset calculation unit 17 to fix the current offset value Foffs. Consequently, after the offset value Foffs is fixed, the offset-removed estimated load Fk, which is inputted from the difference calculation unit 18 to the entrapment determination unit 19, changes following the increase in the first estimated load F1est.

As shown in FIG. 3B, after the offset value Foffs is fixed, the entrapment determination unit 19 determines whether entrapment has occurred by comparing the offset-removed estimated load Fk with an entrapment determination threshold Es. It should be noted that the entrapment determination threshold Es is set to a value greater than the entrapment start determination threshold Et (i.e., Es>Et). When the offset-removed estimated load Fk is lower than or equal to the entrapment determination threshold Es, the entrapment determination unit 19 determines that no entrapment has occurred. Thus, normal operation of the opening/closing body 2 continues.

In contrast, when the offset-removed estimated load Fk exceeds the entrapment determination threshold Es, the entrapment determination unit 19 determines that entrapment has occurred. Then, the entrapment determination unit 19 outputs a notification of the occurrence of entrapment to the opening/closing control unit 3. Upon receipt of the notification of the occurrence of entrapment from the entrapment determination unit 19, the opening/closing control unit 3 operates the actuator 5 in the reverse direction, thereby reversing the opening/closing body 2. Consequently, the opening/closing body 2, which is in the ascending state, starts to descend, thereby releasing the state of an object being entrapped by the opening/closing body 2.

As described above, when the second estimated load F2est inputted from the second filter 16 is lower than or equal to the entrapment start determination threshold Et, the entrapment determination unit 19 allows the opening/closing body 2 to operate normally. Moreover, after the offset value Foffs is fixed, the entrapment determination unit 19 allows the opening/closing body 2 to operate normally for the period of time during which the offset-removed estimated load Fk is lower than or equal to the entrapment determination threshold Es. In contrast, upon the offset-removed estimated load Fk exceeding the entrapment determination threshold Es after the offset value Foffs is fixed, the entrapment determination unit 19 causes the opening/closing body 2 to be reversed. Consequently, it becomes possible to have the opening/closing body 2 ascending or descending optimally.

In the present embodiment, with the first filter 15 and the second filter 16 that have different frequency characteristics, it becomes possible to obtain an output prioritizing the securing of gain by the first filter 15, while obtaining an output prioritizing error suppression by the second filter 16. Performing the entrapment determination by using the output obtained from the first filter 15 which prioritizes the securing of gain, the responsiveness of the entrapment determination can be secured. Moreover, performing the entrapment determination by using the output obtained from the second filter 16 which prioritizes reduction in the error of the estimated load Fest, high detection accuracy can be secured. In this way, the occurrence of entrapment due to the opening/closing body 2 is determined by using both the outputs respectively reflecting the advantages of the first and second filters 15 and 16. Consequently, it becomes possible to achieve both high responsiveness and suppression of erroneous detection of entrapment.

### Effects of Present Embodiment

According to the present embodiment, it is possible to achieve the following advantageous effects.

(1) In the present embodiment, the opening/closing body control apparatus 1 includes the load estimation unit 10, the first filter 15, the second filter 16, the offset calculation unit 17 and the entrapment determination unit 19. The load estimation unit 10 estimates the load caused to the opening/closing body 2 during the opening operation or the closing operation. The first filter 15 removes at least noise from the waveform of the estimated load Fest obtained by the load estimation unit 10. The second filter 16 removes, from the waveform of the estimated load Fest, frequencies lower than those removed by the first filter 15. The offset calculation unit 17 calculates the offset value Foffs of the estimated load Fest based on the output of the first filter 15. The entrapment determination unit 19 performs the entrapment determination for the opening/closing body 2 based on the outputs of the first and second filters 15 and 16. Specifically, the entrapment determination unit 19 monitors whether entrapment has started based on the output of the second filter 16, and performs the entrapment determination based on the offset value Foffs fixed when the start of entrapment is detected and the output of the first filter 15.

With the above configuration, the estimated load Fest obtained by the load estimation unit 10 is filtered by the first filter 15, thereby being converted into a waveform that prioritizes the securing of gain. Moreover, the estimated load Fest obtained by the load estimation unit 10 is also filtered by the second filter 16, thereby being converted into a waveform that prioritizes reduction in the error of the estimated load Fest. Then, both the output of the first filter 15 and the output of the second filter 16 are used to determine whether entrapment has occurred. Performing the entrapment determination by using the waveform that prioritizes the securing of gain, the responsiveness of the entrapment determination can be improved. Moreover, performing the entrapment determination by using the waveform that prioritizes reduction in the error of the estimated load Fest, a determination result having low probability of erroneous detection can be obtained. Consequently, it becomes possible to achieve both high responsiveness and suppression of erroneous detection of entrapment.

(2) The entrapment determination unit 19 determines, when the output of the second filter 16 exceeds the entrapment start determination threshold Et, that entrapment has started and causes the offset calculation unit 17 to fix the offset value Foffs. Moreover, after the offset value Foffs is fixed, the entrapment determination unit 19 further determines, when the difference between the output of the first filter 15 and the fixed offset value Foffs exceeds the entrapment determination threshold Es, that entrapment has occurred. With the above configuration, it becomes possible to detect the start of entrapment by a simple method of setting a predetermined threshold with respect to the output of the second filter 16. Moreover, it also becomes possible to detect the occurrence of entrapment by a simple method of setting a predetermined threshold with respect to the difference between the output of the first filter 15 and the offset value Foffs.

(3) The load estimation unit 10 estimates the load caused to the opening/closing body 2 by using the model P obtained by converting the state-space representation relating to operation of the motor 6, which is the power source of the opening/closing body 2, into the transfer function representation. With the above configuration, it becomes possible to accurately detect the load caused to the opening/closing body 2 by using the model P.

(4) The model P includes the motor model P1 and the inverse model P2⁻¹ The motor model P1 is configured to estimate the angular speed of the motor 6 based on an input that is the motor voltage value vᵢ outputted from the voltage detection unit 11; the voltage detection unit 11 is configured to detect the voltage applied to the motor 6. The inverse model P2⁻¹ is configured to estimate the load caused to the opening/closing body 2 based on an input that is the difference between the estimated angular speed ωest outputted from the motor model P1 and the motor angular speed ω outputted from the speed calculation unit 12; the speed calculation unit 12 is configured to calculate the rotational speed of the motor 6. The load estimation unit 10 is configured to output the output of the inverse model P2⁻¹ as the estimated load Fest to the first and second filters 15 and 16. With the above configuration, the angular speed caused by an external force (i.e., the external-force angular speed ω′) can be accurately determined by calculating the difference between the estimated angular speed ωest obtained by the motor model P1 and the actual motor angular speed ω. Moreover, the load caused by the external force can be accurately estimated by applying the angular speed (i.e., the external-force angular speed ω′) to the inverse model P2⁻¹.

(5) The offset calculation unit 17 is configured to: repeatedly perform, for each computer control cycle, the process of determining, as the offset value Foffs, the average value of a plurality of load values (i.e., values of the first estimated load F1est) traced back from a current time to past times; and fix the offset value Foffs when the start of entrapment is detected. With the above configuration, it becomes possible to correct, even when the offset value Foffs changes suddenly, the output of the first filter 15 with the offset value Foffs that is unaffected by the change. Consequently, it becomes possible to further improve the accuracy of the entrapment determination.

### OTHER EMBODIMENTS

The present embodiment can be modified and implemented as follows. Moreover, the present embodiment and the following modifications can also be implemented in combination with each other to the extent that there is no technical contradiction between them.

The first filter 15 may be configured as, for example, Q₁(s)-Q₂(s) or Q₁(s)+Q₂(s). Similarly, the second filter 16 may also be configured as, for example, Q₁(s)−Q₂(s) or Q₁(s)+Q₂(s).

When calculating the offset value Foffs by taking the average of load values, the calculation is not limited to taking the average of consecutive load values; for example, the offset value Foffs may be calculated by taking the average of every predetermined number of load values.

The determination of the start of entrapment is not limited to the method of comparing the load (i.e., the second estimated load F2est) with the entrapment start determination threshold Et. For example, the start of entrapment may alternatively be determined by a method of calculating an integral value of the load and determining whether the integral value exceeds a predetermined value. In addition, the same applies to the entrapment determination method of comparing the offset-removed estimated load Fk with the entrapment determination threshold Es.

The offset value Foffs is not limited to being calculated by using the arithmetic mean, but may alternatively be calculated by, for example, using a weighted mean, geometric mean or harmonic mean. In other words, the average value is not limited to the arithmetic mean value, but alternatively be any of the aforementioned mean values.

The estimated load is not limited to being calculated by the method of using the model P, but may alternatively be calculated by, for example, a method of using general equations (such as a voltage equation and an equation of motion).

The entrapment detection function may be applied only to the opening operation, or only to the closing operation. Moreover, the entrapment detection function may be applied to both the opening operation and the closing operation.

The load estimation unit 10, the first filter 15, the second filter 16, the offset calculation unit 17 and the entrapment determination unit 19 may be configured with: (1) one or more processors that operate in accordance with a computer program (i.e., software); or (2) a combination of such processor(s) and one or more dedicated hardware circuits, such as Application-Specific Integrated Circuits (ASICs), that execute at least some of various processes (or steps). A processor includes a CPU and a memory such as a RAM or a ROM; and the memory stores program code or instructions configured to cause the CPU to execute the processes. Moreover, examples of a memory (computer-readable medium) include any available media that can be accessed by a general-purpose or dedicated computer. Alternatively, instead of a computer including the above-described processor, a processing circuit may be employed which consists of one or more dedicated hardware circuits that execute all of the various processes.

The load estimation unit 10, the first filter 15, the second filter 16, the offset calculation unit 17 and the entrapment determination unit 19 may be configured respectively with independent processors; or some of their functions may be realized by a common processor. That is, the load estimation unit 10, the first filter 15, the second filter 16, the offset calculation unit 17 and the entrapment determination unit 19 are not limited to independent functional blocks, but may alternatively be configured with a single functional block, or with functional blocks that share a part with each other.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

The following notes summarize the technical features derived from the present disclosure.

[1] An opening/closing body control apparatus (1) comprising:
a load estimation unit (10) configured to estimate a load caused to an opening/closing body (2) during an opening operation or a closing operation;
a first filter (15) configured to remove at least noise from a waveform of the estimated load (Fest) obtained by the load estimation unit;
a second filter (16) configured to remove, from the waveform of the estimated load, frequencies lower than those removed by the first filter;
an offset calculation unit (17) configured to calculate an offset value (Foffs) of the estimated load based on an output of the first filter; and
an entrapment determination unit (19) configured to perform an entrapment determination for the opening/closing body based on the output of the first filter and an output of the second filter,
wherein
the entrapment determination unit is further configured to:
monitor whether entrapment has started based on the output of the second filter; and
perform the entrapment determination based on the offset value fixed when the start of entrapment is detected and the output of the first filter.

[2] The opening/closing body control apparatus according to the first note, wherein the entrapment determination unit is further configured to:
determine, when the output of the second filter exceeds an entrapment start determination threshold (Et), that entrapment has started and cause the offset calculation unit to fix the offset value; and
determine, when, after the offset value is fixed, a difference between the output of the first filter and the fixed offset value exceeds an entrapment determination threshold (Es), that entrapment has occurred.

[3] The opening/closing body control apparatus according to the first or second note, wherein the load estimation unit is further configured to estimate the load caused to the opening/closing body by using a model (P) obtained by converting a state-space representation relating to operation of a motor (6), which is a power source of the opening/closing body, into a transfer function representation.

[4] The opening/closing body control apparatus according to the third note, further comprising:
a voltage detection unit (11) configured to detect a voltage applied to the motor; and
a speed calculation unit (12) configured to calculate a rotational speed of the motor,
wherein
the model comprises:
a motor model (P1) configured to estimate an angular speed of the motor based on an input that is a motor voltage value (vi) outputted from the voltage detection unit; and
an inverse model (P2⁻¹) configured to estimate the load caused to the opening/closing body based on an input that is a difference between the estimated angular speed (ωest) outputted from the motor model and a motor angular speed (ω) outputted from the speed calculation unit, and
wherein
the load estimation unit is further configured to output an output of the inverse model as the estimated load to the first and second filters.

[5] The opening/closing body control apparatus according to any one of the first to fourth notes, wherein the offset calculation unit is further configured to:
repeatedly perform, for each computer control cycle, a process of determining, as the offset value, an average value of a plurality of values of the load traced back from a current time to past times; and
fix the offset value when the start of entrapment is detected.

[6] An entrapment detection method of detecting, by a computer, entrapment of an object due to an opening/closing body (2) during an opening operation or a closing operation, the entrapment detection method comprising:
a step of estimating a load caused to the opening/closing body during the opening operation or the closing operation;
a step of removing, by a first filter (15), at least noise from a waveform of the estimated load (Fest) obtained in the estimating step;
a step of removing, by a second filter (16), frequencies from the waveform of the estimated load, the frequencies being lower than those removed by the first filter;
a step of calculating an offset value (Foffs) of the estimated load based on an output of the first filter;
a step of monitoring whether entrapment has started based on an output of the second filter;
a step of fixing the offset value when the start of entrapment is detected based on the output of the second filter; and
a step of performing an entrapment determination based on the fixed offset value and the output of the first filter.

What is claimed is:

1. An opening/closing body control apparatus comprising:
a load estimation unit configured to estimate a load caused to an opening/closing body during an opening operation or a closing operation;
a first filter configured to remove at least noise from a waveform of the estimated load obtained by the load estimation unit;
a second filter configured to remove, from the waveform of the estimated load, frequencies lower than those removed by the first filter;
an offset calculation unit configured to calculate an offset value of the estimated load based on an output of the first filter; and
an entrapment determination unit configured to perform an entrapment determination for the opening/closing body based on the output of the first filter and an output of the second filter,
wherein
the entrapment determination unit is further configured to:
monitor whether entrapment has started based on the output of the second filter; and
perform the entrapment determination based on the offset value fixed when the start of entrapment is detected and the output of the first filter.

2. The opening/closing body control apparatus as set forth in claim 1, wherein the entrapment determination unit is further configured to:
determine, when the output of the second filter exceeds an entrapment start determination threshold, that entrapment has started and cause the offset calculation unit to fix the offset value; and
determine, when, after the offset value is fixed, a difference between the output of the first filter and the fixed offset value exceeds an entrapment determination threshold, that entrapment has occurred.

3. The opening/closing body control apparatus as set forth in claim 1, wherein the load estimation unit is further configured to estimate the load caused to the opening/closing body by using a model obtained by converting a state-space representation relating to operation of a motor, which is a power source of the opening/closing body, into a transfer function representation.

4. The opening/closing body control apparatus as set forth in claim 3, further comprising:
a voltage detection unit configured to detect a voltage applied to the motor; and
a speed calculation unit configured to calculate a rotational speed of the motor,
wherein
the model comprises:
a motor model configured to estimate an angular speed of the motor based on an input that is a motor voltage value outputted from the voltage detection unit; and
an inverse model configured to estimate the load caused to the opening/closing body based on an input that is a difference between the estimated angular speed outputted from the motor model and a motor angular speed outputted from the speed calculation unit, and
wherein
the load estimation unit is further configured to output an output of the inverse model as the estimated load to the first and second filters.

5. The opening/closing body control apparatus as set forth in claim 1, wherein the offset calculation unit is further configured to:
repeatedly perform, for each computer control cycle, a process of determining, as the offset value, an average value of a plurality of values of the load traced back from a current time to past times; and
fix the offset value when the start of entrapment is detected.

6. An entrapment detection method of detecting, by a computer, entrapment of an object due to an opening/closing body during an opening operation or a closing operation, the entrapment detection method comprising:
a step of estimating a load caused to the opening/closing body during the opening operation or the closing operation;
a step of removing, by a first filter, at least noise from a waveform of the estimated load obtained in the estimating step;
a step of removing, by a second filter, frequencies from the waveform of the estimated load, the frequencies being lower than those removed by the first filter;
a step of calculating an offset value of the estimated load based on an output of the first filter;
a step of monitoring whether entrapment has started based on an output of the second filter;
a step of fixing the offset value when the start of entrapment is detected based on the output of the second filter; and
a step of performing an entrapment determination based on the fixed offset value and the output of the first filter.
